(19) United States
(12) Patent Application Publication
(10) Pub. No.: US 2024/0374451 A1
(43) Pub. Date: Nov. 14, 2024

(54) RIGHT/LEFT SYMMETRICAL INSTRUMENT AND SUCTION HOSE ADAPTERS

(71) Applicant: DENTSPLY SIRONA Inc., York, PA (US)

(72) Inventor: Jochen HUCH, Frankfurt (DE)

(73) Assignee: DENTSPLY SIRONA Inc., York, PA (US)

(21) Appl. No.: 18/686,649

(22) PCT Filed: Aug. 24, 2022
(86) PCT No.: PCT/EP2022/073587

§ 371 Date: Feb. 26, 2024

(30) Foreign Application Priority Data
Aug. 30, 2021 (EP) 21193781.8

(51) Int. Cl. A61G 15/16

(52) U.S. Cl. CPC A61G 15/16

(57) ABSTRACT

A dental treatment unit with a water unit including a water collector with an inlet for water and cleaning chemicals and an outlet; a removable instrument hose adapter for plugging into a first slot of the water collector, the instrument hose adapter having one or more openings for connecting instrument hoses. In the plugged-in state the openings are in fluid communication with the outlet. The dental treatment unit also includes; a removable suction hose adapter for plugging into a second slot of the water collector, the suction hose adapter having one or more openings for connecting suction hoses, in the plugged-in state the openings are in fluid communication with the inlet. Further, the instrument hose adapter and the suction hose adapter are designed to be interchangeable with one another, so that each can be optionally plugged into the first slot or into the second slot.

The entire content of the priority application EP21193781.8 is hereby incorporated by reference to this international application under the provisions of the PCT.

### TECHNICAL FIELD OF THE INVENTION

The present invention relates to dental treatment units.

### BACKGROUND OF THE INVENTION

FIGS. 1a to 1b each show prior art treatment units (1). As shown in FIG. 1b, the water unit (2) is rotatably mounted and can be positioned to the right (see FIG. 1c) or left (see FIG. 1a) of the patient chair (1a).

Right-handed unit: During the instrument hose cleaning process as shown in FIG. 1a, with the water unit (2) standing to the left of the patient chair (1a), the instrument hoses (5) must be routed to the instrument hose adapter located on the side of the water unit (2) facing towards the chair and plugged in. During the suction hose cleaning process, as shown in FIG. 1a, with the water unit (2) standing to the left of the patient chair (1a), the suction hoses (7) must be routed to the suction hose adapter located on the side of the water unit (2) facing away from the chair and plugged in.

Left-handed unit: On the other hand, during the instrument hose cleaning process as shown in FIG. 1C, with the water unit (2) positioned to the right of the patient chair (1a), the instrument hoses (5) must be guided to the instrument hose adapter arranged on the side of the water unit (2) facing away from the chair and plugged in. Thereby, there is a risk that the hoses (5) will be severely kinked and damaged as a result. During the suction hose cleaning process, as shown in FIG. 1c, with the water unit (2) positioned to the right of the patient chair (1a), the suction hoses (7) must be routed to the suction hose adapter located on the side of the water unit (2) facing the chair and plugged in. The start button for the suction hose cleaning process, which is located on the suction hose adapter, must also be actuated across the patient chair (1a). Both the plugging in of the suction hoses (7) and the pressing of the start button can occur several times during a suction hose cleaning process. Therefore, operating the suction hose cleaning process across the patient chair (1a) is extremely ergonomically unfavorable. Since the suction hose cleaning process should be performed after each treatment, the dental treatment unit is unsatisfactory for left-handed units.

The hygiene of the dentist and assistant elements of a treatment unit is of crucial importance for dental work. In the prior art, there is the problem that the instrument and suction hose adapters in the respective left and right arrangements of the water unit can have limited accessibility and operability.

### DISCLOSURE OF THE INVENTION

Currently, the inventors are not aware of any prior art treatment unit in which the instrument and suction hose adapters can be interchanged in their position in the water unit.

An objective of the invention is to provide a treatment unit or a rotatable treatment unit in which the cleaning processes can be carried out equally efficiently with the water unit standing on the right or on the left.

This objective is achieved by the dental treatment unit according to claim 1. The subject-matters of the dependent claims relate to further developments.

The dental treatment unit according to the invention has a water unit. The water unit comprises a water collector having an inlet for water and cleaning chemicals and an outlet; a removable instrument hose adapter for insertion into a first slot of the water collector, wherein the instrument hose adapter has one or more openings for connecting instrument hoses, wherein when inserted, the openings are in fluid communication with the outlet; a removable suction hose adapter for insertion into a second slot of the water collector, wherein the suction hose adapter has one or more openings for connecting suction hoses, wherein, when inserted, the openings are in fluid communication with the inlet. Whereby the instrument hose adapter and the suction hose adapter are designed to be interchangeable with each other so that each can be optionally inserted into the first slot or into the second slot.

A major advantageous effect of the present invention is that the dental treatment unit according to the invention is unrestrictedly right-left compatible compared to known treatment units. The instrument hose adapters and suction hose adapters can be removed, exchanged and inserted into the respective “favorable” side of the water unit by the users themselves in a few simple steps. No technician intervention is required, no settings need to be made or changed on the treatment unit.

Another major advantageous effect of the treatment unit according to the invention is that the instrument hose adapter and suction tube adapter enable improved hygiene due to their removability. The instrument hose adapter and suction hose adapter can themselves be cleaned easily and efficiently e.g., in the thermal disinfector. In the water collector, which becomes exposed when the instrument hose adapter and the suction hose adapter are removed, contamination and deposits can be easily removed, e.g., by wiping them out manually.

Another major advantageous effect of the treatment unit according to the invention is that it allows users to carry out the necessary hygiene measures efficiently. A high degree of automation and the integration of the instrument hose adapter and suction hose adapter into the water unit of the treatment unit increase the ease of use.

In an advantageous embodiment, the suction hose adapter has a reservoir designed to hold a predefined amount of water or cleaning chemical from the inlet. Thanks to the reservoir, a predefined amount of liquid can be drawn into the suction hoses during the suction hose cleaning.

In advantageous embodiments, the suction hose adapter has an integrated start button for suction hose cleaning. The start button can be a magnetic switch, an optical switch or an electromechanical switch. Thanks to the integrated start button, the suction hose cleaning can always be started on the side of the suction hose adapter.

In advantageous embodiments, the suction hose adapter and the instrument hose adapter each have a locking device for locking the same in the inserted slot. The locking device can be provided in the form of snap locks, clamp locks, screw locks, latching elements. Thanks to the locking devices, the adapters can be securely fastened or easily removed.

### BRIEF DESCRIPTION OF THE DRAWINGS

In the following description, the present invention will be explained in more detail by means of exemplary embodiments and with reference to the drawings, wherein

FIG. 1a—shows a dental treatment unit from the state of the art in which the water unit is located to the left of the patient chair;

FIG. 1b—shows the dental treatment unit from FIG. 1a while the water unit is rotated from left to right of the patient chair;

FIG. 1c—shows a dental treatment unit from FIG. 1a in which the water unit is located to the right of the patient chair;

FIG. 2a—shows a partial view of a dental treatment unit according to one embodiment, wherein a lid is arranged in front of the instrument hose adapter;

FIG. 2b—shows a partial view of a dental treatment unit from FIG. 2a, wherein the lid has been removed from the front of the instrument hose adapter;

FIG. 3a—shows a partial view of the treatment unit according to one embodiment of the invention with removable and interchangeable instrument tube adapter and suction tube adapter, wherein the user removes the instrument hose adapter from the slot;

FIG. 3b—shows a partial view of the treatment unit according to one embodiment of the invention with removable and interchangeable instrument hose adapter and suction hose adapter, wherein the user cleans the slot in the water collector;

FIG. 3c—shows a partial view of the treatment unit according to one embodiment of the invention with removable and interchangeable instrument hose adapter and suction hose adapter, wherein the user removes the suction hose adapter from the slot;

FIG. 3d—shows a partial view of the treatment unit according to one embodiment of the invention with removable and interchangeable instrument hose adapter and suction hose adapter, wherein the user cleans the slot in the water collector;

FIG. 4a—shows an enlarged detailed view of the water collector, instrument hose adapter, and suction hose adapter according to one embodiment of the invention;

FIG. 4b—shows an enlarged detailed view of the water collector, instrument hose adapter and suction hose adapter according to one embodiment of the invention, wherein the instrument hose adapter and the suction hose adapter have been interchanged with each other;

FIG. 5a—shows an exploded view of the water collector, instrument hose adapter and suction hose adapter of FIG. 4a;

FIG. 5b—shows an exploded view of the water collector, instrument hose adapter and suction hose adapter of FIG. 4b;

FIG. 6a—shows a cross-sectional view of the water collector, instrument hose adapter and suction hose adapter from FIG. 4a;

FIG. 6b—show cross-sectional view of the water collector, instrument hose adapter and 5 suction hose adapter from FIG. 4b;

FIGS. 7a-7b—show a suction hose cleaning sequence according to one embodiment of the invention;

FIGS. 8a-8b—show a sequence of instrument tube cleaning according to one embodiment of the invention.

The reference numbers shown in the drawings designate the elements listed below, which are referred to in the following description of exemplary embodiments.
1. Dental treatment unit
1a. Patient chair
1b. Rotating mechanism
1c. Dentist element (Tray)
1d. Assistant element (Tray)
2. Water unit (tower)
3. Water collector
3a. Inlet
3b. Outlet (Drain)
3c1. First slot
3c2. Second slot
3d. Cover
4. Instrument hose adapter (slot)
4a. Opening
5. Instrument hose
6. Suction hose adapter (slide-in)
6a. Opening
6b. Reservoir
6c. Start button
6c1. Reed switch
7. Suction hose

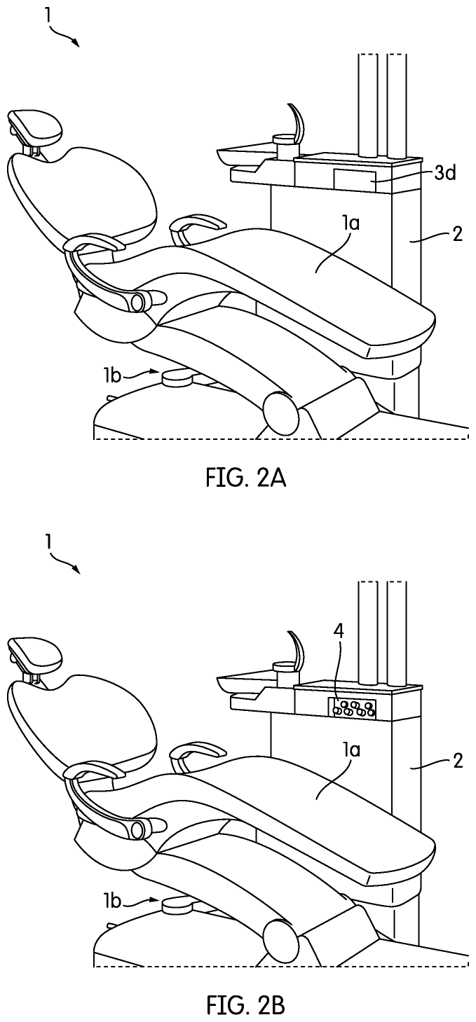

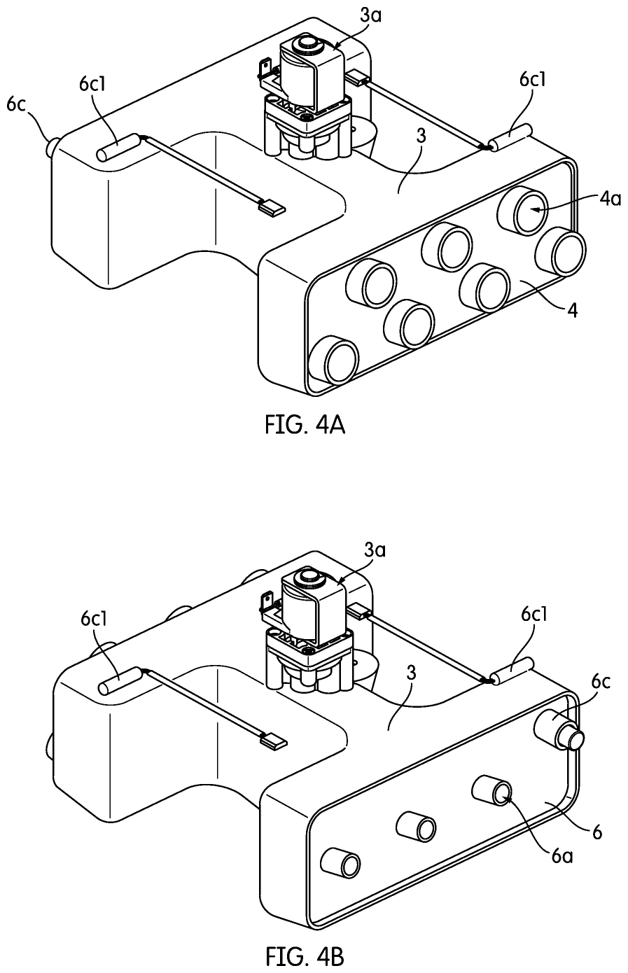

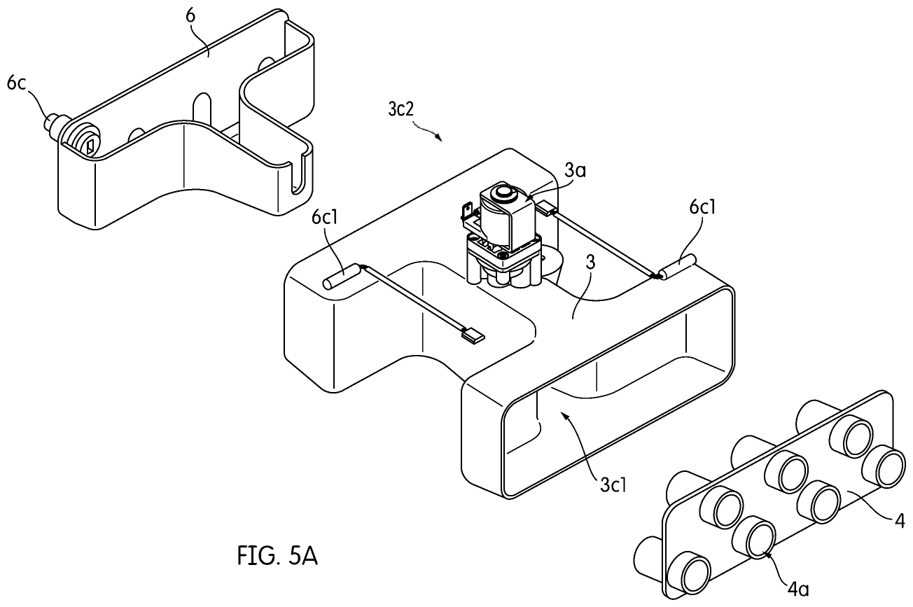

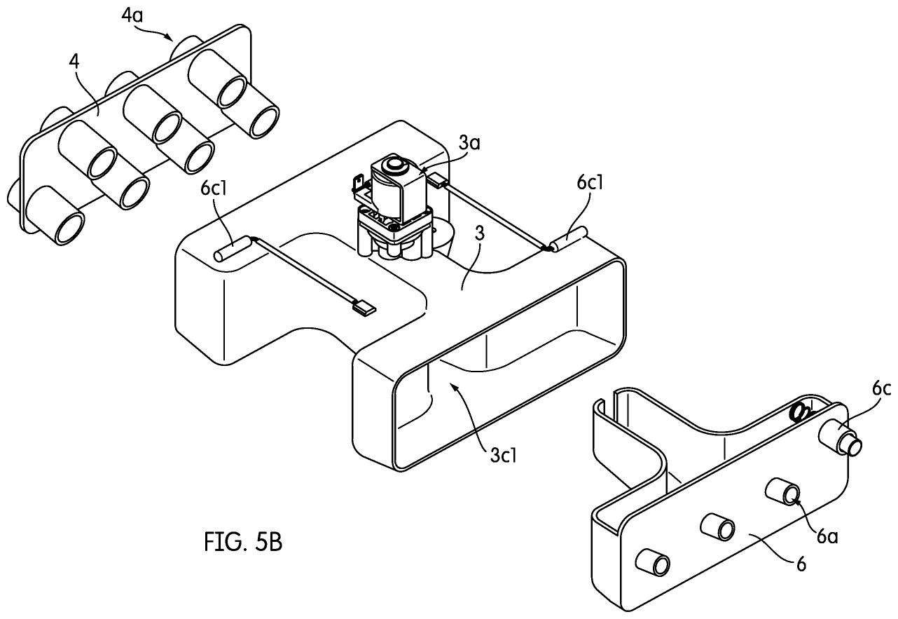

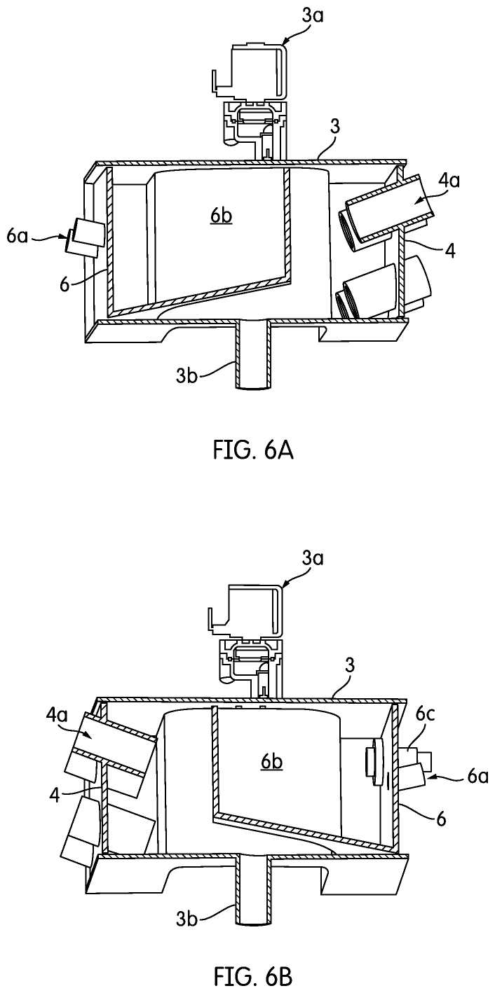

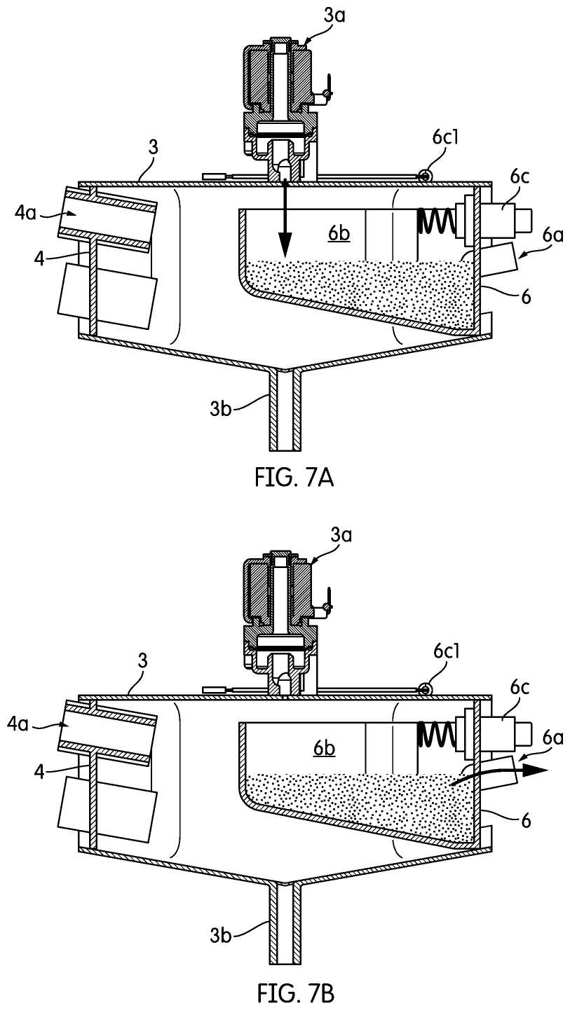

FIGS. 2a and 2b each partially show a dental treatment unit (1) according to the invention which has a water unit (2). The water unit (2) is located on the left side of the patient chair (1a). However, it can be placed on the right side of the patient chair (1a) by means of a rotating mechanism (1b). As shown in FIGS. 6a and 6b, the water unit (2) includes a water collector (3) with an inlet (3a) for water and cleaning chemicals and an outlet (3b). The water collector (3) preferably has a funnel-shaped bottom (FIG. 7A). Alternatively, the bottom can be made flat or take other geometric shapes. The outlet (3b) is connected to a wastewater system not shown. As shown in FIGS. 4a and 5a, the water unit (2) includes a removable instrument hose adapter (4) for insertion into a first slot (3c1) of the water collector (3). The instrument hose adapter (4) has one or more openings (4a) for connecting instrument hoses (5). As shown in FIGS. 6a and 6b in the inserted state, the openings (4a) are in fluid communication with the outlet (3b). As shown in FIGS. 4b and 5b, the water unit (2) includes a removable suction hose adapter (6) for insertion into a second slot (3c2) of the water collector (3). The suction hose adapter (6) has one or more openings (6a) for connecting suction hoses (7). As shown in FIGS. 6a and 6b in the inserted state, the openings (6a) are in fluid communication with the inlet (3a). As shown in FIGS. 6a and 6b, the suction hose adapter (6) preferably has a reservoir (6b) designed to receive water and cleaning chemicals from the inlet (3a). The reservoir (6b) on the suction hose adapter (6) is designed in such a way that it protrudes across the center of the water collector (2) when inserted and can receive the supplied water and cleaning chemical-no matter from which side it is inserted into the water collector (2). Preferably, the supply of water and cleaning chemical is centered on the water collector (2). If the suction hose adapter (6) is not inserted, the supplied water and cleaning chemical would thereby flow into the drain (3b) of the water collector (2). Alternatively, the openings (6a) can be designed to be directly connectable to the inlet (3a) via one or more safety valves (not shown). Thus, the use of a reservoir (6b) can be omitted. As shown in FIGS. 4a to 5b, the instrument hose adapters (4) and the suction hose adapter (6) are designed to be interchangeable with each other so that each can be optionally plugged into the first slot (3c1) or into the second slot (3c2).

The shape of the water collector (2) and the adapters (4; 6) does not necessarily have to be H-shaped, as shown. Other designs can also be used, which enable interchangeability. The water collector (2) and the adapters (4,6) may alternatively be box-shaped or the like. Crucial to the invention is the symmetrical design of the water collector (2) or interchangeability, namely the identical interface or slots (3c1;3c2) for the instrument and suction hose adapters (4;6) preferably on the opposite right and left sides on the water collector (2).

The suction hose adapter (6) and the instrument hose adapter (4) preferably each have a locking device (not shown) for locking the same in the inserted slot (31c1;3c2). The locking device may have a force-fitting connection and/or a form-fitting connection. For example, snap locks, clamp locks, screw locks, latching elements, etc. can be used individually or in combination.

### Cleaning Processes

The cleaning processes are explained in more detail in the following description. The integrated cleaning processes are intended to make it easier for the users of the treatment unit according to the invention to keep the instrument couplings and their hoses (5;7) hygienic.

The following cleaning processes are provided for the dentist element (1c):
(Auto) Purge=flushing the instrument hoses (5) and instrument couplings with water.
Sanitation=flushing the instrument hoses (5) and instrument couplings with disinfectant.

The following cleaning processes are provided for the assistant element (1d):
Optional sprayvit of the assistant element (1d): Sanitation together with the instruments of the dentist element (1c).
Suction hose cleaning=flushing the suction hoses (7) with water and optionally cleaning chemicals.

### Purge/Sanitation

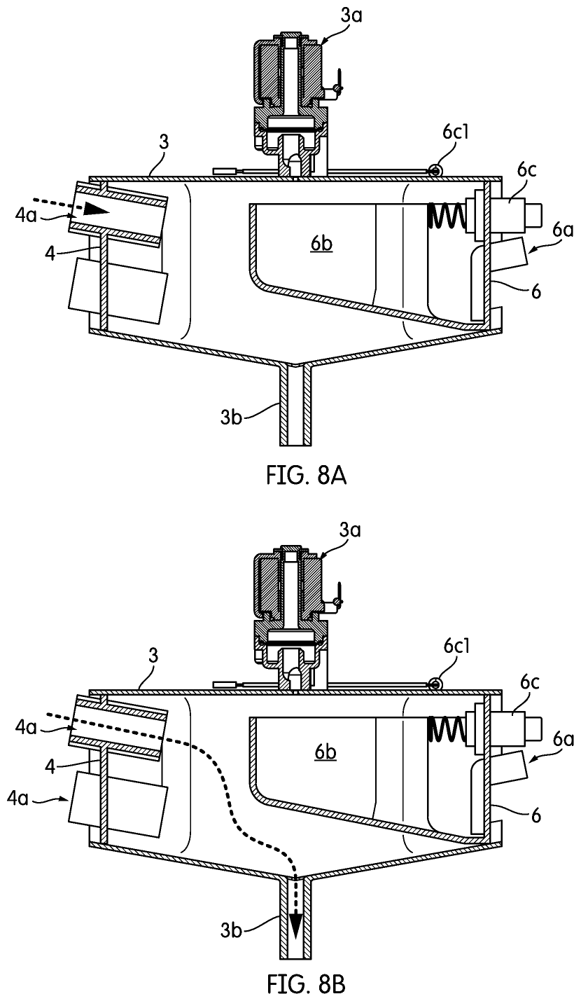

Purge/sanitation is the cleaning process on the treatment unit (1) for the instruments of the dentist element (1c) and their hoses (5) by flushing water or disinfectant. Purge describes the flushing of the water paths of the treatment instruments with water. Sanitation describes the flushing of the water paths of the treatment instruments with disinfectant. The procedure is as follows and is partially shown in FIGS. 8a and 8b:
1. The purge/sanitation process is started on the user interface of the dentist element (1c). The dialog shown there executes the purge process;
2. Insert suction instruments into the openings (4a) (instruments are not shown in FIGS. 8a and 8b).
3. After all instruments to be purged/sanitized have been inserted, the purge/sanitization process is continued by making inputs through the user interface;
4. The water paths of the instruments to be purged/sanitized are flushed with water or disinfectant.

The water/disinfectant flows from the instruments into the water collector (2); from there it flows through the outlet (3b) of the water collector into the wastewater system (not shown) of the dental treatment unit (1).

### Suction Hose Cleaning

Suction hose cleaning is the cleaning process on the treatment unit (1) for the suction instruments of the assistant element (1d) and their hoses (7) by vacuuming larger quantities (preferably approx. 200 ml) of water or water mixed with special cleaning chemicals (optional facility). The procedure is as follows and partially shown in FIGS. 7a and 7b:
1. Plug in the suction instruments to the openings (6a) (suction instruments are not shown in FIGS. 7a and 7b);
2. Press the start button (6c);
3. The reservoir (6b) on the suction hose adapter (6) is filled with water (with chemical admixture if optional facility is selected) through the inlet (3a);
4. The plugged-in suction instruments are automatically activated, and the liquid is sucked out of the reservoir (6b) of the suction hose adapter (6) by the plugged-in suction instruments. (The suction pumping system of the wastewater system is known to the person skilled in the art and is not explained in detail here).

The suction hose adapter (6) has optionally an integrated start button (6c) for suction hose cleaning. The start button (6c) for suction hose cleaning is integrated in the suction hose adapter (6). As a result, the start button (6c) for suction hose cleaning is always located on the side of the suction hose adapter (6). Different embodiments for the start button (6c) can be considered. In one embodiment, the start button (6c) has an integrated magnet that activates a reed switch (6c1) or Hall sensor when actuated. The reed switches (6c1) can be arranged symmetrically on the water collector (2) as shown in FIGS. 5a and 5b. In another embodiment, the water collector (2) has symmetrically arranged and integrated light barrier sensors (not shown) which can be interrupted by the start button (6c). In a further embodiment, the water collector (2) has symmetrically arranged microswitches which, by mechanical actuation of the start button (6c), trigger an electrical impulse to start the suction hose cleaning. Thus, electrical, magnetic or optical mechanisms can be used. Alternatively, the water collector (2) or the housing around the water collector (2) can also be equipped only with a centrally arranged reed switch (6c1) (or Hall sensor or light barrier sensor or microswitch).

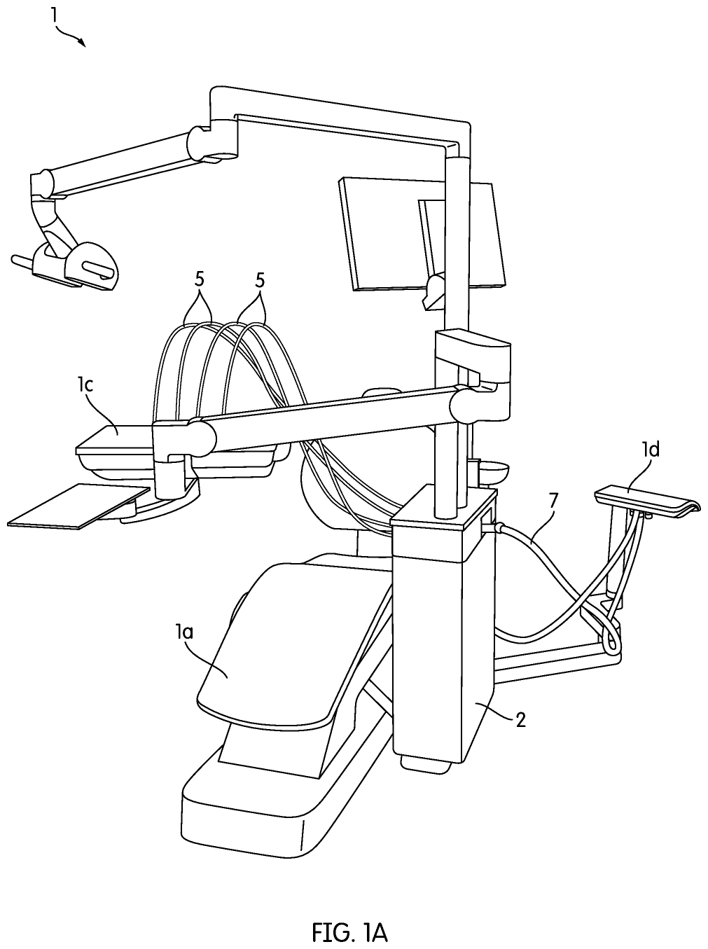

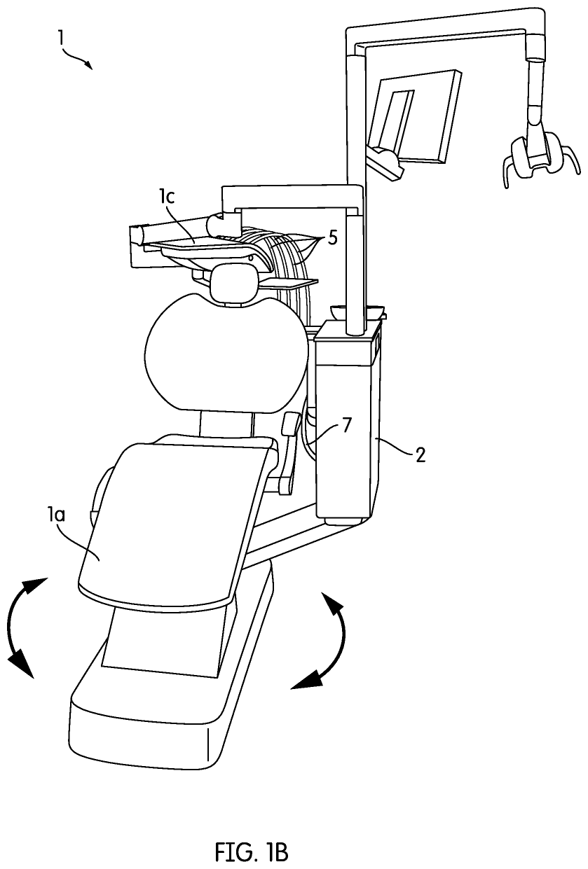

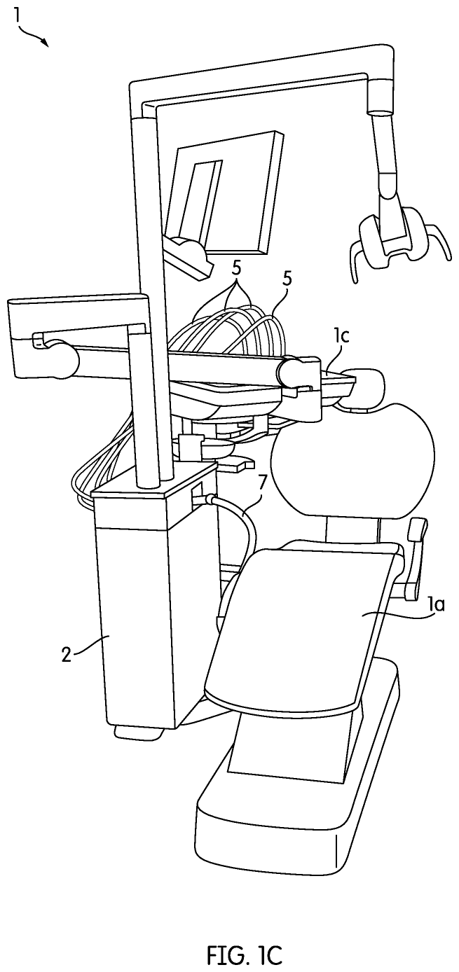

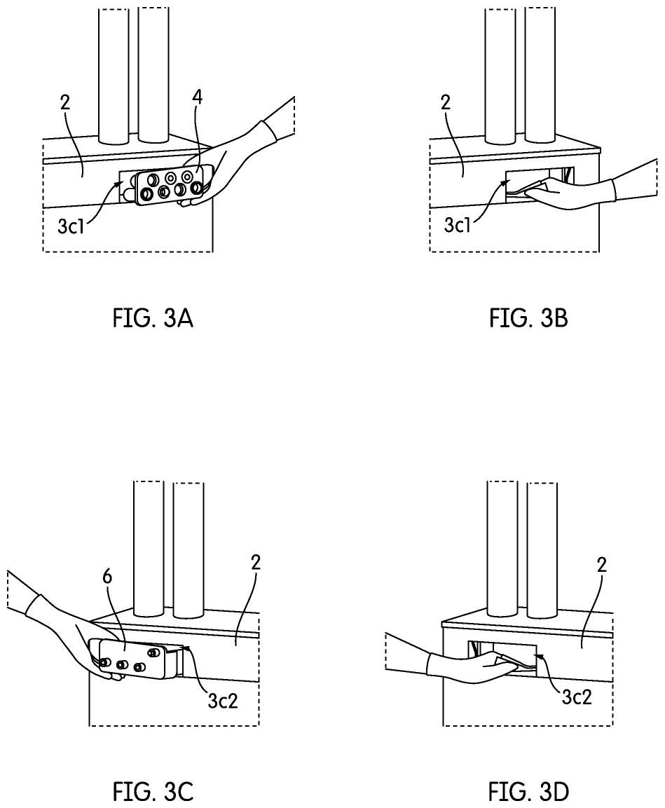

For comparison, FIGS. 1a to 1c show “rotatable” dental treatment units (1) according to the prior art in which the instrument hose adapter and the suction hose adapter are not removable and are not interchangeable. Compared to the prior art, a major advantageous effect of the present invention is that the dental treatment unit (1) according to the invention is unrestrictedly right-left compatible compared to known treatment units. The instrument hose adapter (4) and suction hose adapter (6) can be manually removed, exchanged and inserted into the respective “favorable” side of the water unit (2) by the users themselves in a few simple steps. No technician intervention is required, no settings need to be made or changed on the treatment unit (2). The instrument hose adapter (4) and the suction hose adapter (6) have the same geometric interface to the water collector (2) and can be plugged into either the right or the left slot (3c1;3c2) of the water collector (2). As shown in FIG. 3a to 3d, the user can remove the instrument hose adapter (4) or the suction hose adapter (6) from the water collector (2) and clean the slots (3c1;3c2).

1. A dental treatment unit with a water unit comprising
a water collector including an inlet for water and cleaning chemicals and an outlet;
a removable instrument hose adapter configured to be inserted in a first slot of the water collector, the instrument hose adapter including one or more openings configured to connect instrument hoses, in the inserted state the openings are in fluid communication with the outlet;
a removable suction hose adapter configured to be inserted into a second slot of the water collector, the suction hose adapter including one or more openings configured to connect suction hoses, in the inserted state the openings are in fluid communication with the inlet,
wherein the instrument hose adapter and the suction hose adapter are configured to be interchangeable with one another, so that each can be optionally inserted into the first slot or into the second slot.

2. The dental treatment unit according to claim 1, wherein the suction hose adapter has a reservoir which is configured to receive water and cleaning chemicals from the inlet.

3. The dental treatment unit according to claim 1, wherein the suction hose adapter has an integrated start button for suction hose cleaning.

4. The dental treatment unit according to claim 1, wherein the suction hose adapter and the instrument hose adapter each have a locking device for locking the same in the inserted slot.
